(19) United States
(12) Patent Application Publication
(10) Pub. No.: US 2016/0370484 A1
(43) Pub. Date: Dec. 22, 2016

(54) SYSTEMS AND METHODS TO REDUCE NOISE IN SEISMIC DATA USING A FREQUENCY DEPENDENT CALENDAR FILTER

(71) Applicant: CGG SERVICES SA, Massy Cedex (FR)

(72) Inventors: Julien COTTON, Paris (FR); Cecile BERRON, Massy (FR); Eric FORGUES, Bures-sur-Yvette (FR)

(21) Appl. No.: 15/122,279

(22) PCT Filed: Mar. 3, 2015
(86) PCT No.: PCT/IB2015/000501

§ 371 Date: Aug. 29, 2016

Related U.S. Application Data
(60) Provisional application No. 61/948,454, filed on Mar. 5, 2014.

(51) Int. Cl. G01V 1/36; G01V 1/30

(52) U.S. Cl. CPC G01V 1/364; G01V 1/308; G01V 2210/324; G01V 2210/6122

(57) ABSTRACT

The present disclosure includes a method for reducing noise in seismic data using a frequency dependent calendar filter. The method for reducing noise in input seismic trace data includes obtaining a plurality of input seismic trace data, the plurality of input seismic trace data including a plurality of controlled signals and a plurality of uncontrolled signals, identifying a frequency content of the plurality of uncontrolled signals, and selecting a frequency dependent calendar filter based on the frequency content of the plurality of uncontrolled signals. The method further includes applying the frequency dependent calendar filter to the plurality of input seismic data to generate a plurality of output noise-reduced seismic traces. The present disclosure also includes associated systems and apparatuses.

### CROSS-REFERENCE TO RELATED APPLICATION

This application claims the benefit under 35 U.S.C. §119(e) of United States Provisional Application Ser. No. 61/948,454 filed on Mar. 5, 2014, which is incorporated by reference in its entirety for all purposes.

### TECHNICAL FIELD

The present disclosure relates generally to seismic imaging and, more particularly, to systems and methods to reduce noise in seismic data using a frequency dependent calendar filter.

### BACKGROUND

Seismic exploration, whether on land or at sea, is a method of detecting geologic structures below the surface of the earth by analyzing seismic energy that has interacted with the geologic structures. A seismic energy source generates a seismic signal that propagates into the earth, where the signal may be partially reflected, refracted, diffracted, and/or otherwise affected by one or more geologic structures such as, for example, interfaces between underground formations having varying acoustic impedances. Seismic imaging systems include one or more sources that can be arranged in various configurations. For example, sources can be placed at or near the earth's surface, on or within bodies of water, or below the earth's surface. Seismic sources can be controlled or uncontrolled. A “controlled source” is a source that deliberately generates seismic signals at the control of the seismic imaging system. A seismic wave that is deliberately generated by a controlled source at the direction of the seismic imaging system is referred to as a “controlled signal” or an “active signal,” and the images resulting from the processing of these signals are referred to as “controlled seismic data” or “active seismic data.” An “uncontrolled source” is a source that produces a seismic wave that is not deliberately generated by the seismic imaging system. A seismic wave that is generated by an uncontrolled source is referred to as an “uncontrolled signal” or a “passive signal.”

Seismic receivers placed at or near the earth's surface, within bodies of water, or below the earth's surface in well-bores are able to detect the seismic signals and transmit them to a seismic data tool. The signals are processed to generate information about the location and physical properties of the subsurface geologic structures that interacted with the seismic signal. An individual receiver may receive and transmit amplitude of seismic signals as a function of time. Data representing an amplitude of seismic signals as a function of time may be called a seismic trace. A set of seismic traces collected during a particular time period may be referred to as a “survey.” One or more seismic traces from a single survey can be used to generate an image of subsurface formations. Such images, referred to as “2D images” or “3D images,” indicate the state of the subsurface formations during the time period in which the survey was taken. Features of a 3D image related to the state of the subsurface formations may be considered “3D signal” or “3D signature” while other unwanted elements of the image may be considered “noise” or “3D noise.” Often, 3D noise is random or uncorrelated to 3D signals. Thus, the contribution of 3D noise to a 3D image may randomly vary in both sign and in amplitude.

3D images are typically generated from processing of seismic traces measured from controlled sources. However, in certain systems, 3D noise may appear in one or more seismic traces as a result of uncontrolled seismic sources proximate to the area of a survey. For example, construction work, combustion engines, electrical power delivery systems, or other uncontrolled seismic sources might contribute to the noise affecting a 3D image. These uncontrolled sources can distort seismic images, causing 3D images from different surveys to show differences that result from uncontrolled sources rather than structural changes in the layers or reservoir that are relevant to production.

Seismic data can be collected at different times. This type of analysis is referred to as “time-lapse” or “4D” imaging. “Permanent Reservoir Monitoring” (PRM), or “Continuous Reservoir Monitoring” (CRM) is used to perform 4D imaging near a reservoir over an extended period of time, though such implementations need not be permanent or continuous. Performance of 4D imaging may also be referred to as generating a “Calendar Seismic Record” (CSR).

4D processing of multiple seismic datasets corresponding to different times facilitates the determination of how and where the Earth's properties have changed during that time period. Seismic datasets corresponding to different times are referred to as different “vintages.” Because 4D images are generated from seismic data acquired at different times, 4D images measure changes in subsurface formations over time. For example, 4D images may be developed in a reservoir before and after a period of production. Such 4D images are used to identify reservoir activity of interest such as, for example, fluid movements or changes in fluid or lithological properties in and around a reservoir. However, like 3D images, 4D images may additionally include recording of uncontrolled or passive signals. Features of a 4D image related to fluid production may be considered “4D signal” or “4D signature” while other unwanted elements of the image may be considered “4D noise.”

4D processing may include comparing 3D images generated at different times. For example, 3D images from different vintages can be analyzed to identify differences in the subsurface structures. Thus, 3D images from different vintages can be differenced to generate “4D images,” which are also referred to as “4D differences” or “4D effects.” However, 3D noise incorporated into 3D images may obscure differences in subsurface structures, or may cause differences to appear that do not actually correspond to subsurface structures, thereby reducing the accuracy of the 4D images. One goal of 4D processing is to attenuate 4D noise relative to a 4D signal in order to maximize the signal-to-noise ratio of 4D images.

Sequences of 4D images may be produced where each 4D image corresponds to the status of subsurface formations at a particular time. The temporal difference between successive 4D images may be referred to as the “calendar resolution.” Existing techniques for maximizing signal-to-noise ratio in 4D images suffer from significant drawbacks, including a reduction in calendar resolution of the CSR.

For example, one technique for increasing signal-to-noise ratio is to additively combine multiple successive seismic traces before generating the 3D images used in performing 4D processing. Because noise in seismic traces is often uncorrelated to signals generated by controlled seismic sources, additively combining successive seismic traces may constructively amplify the 3D signals, while also causing destructive interference to the seismic trace noise. However, because the frequency with which seismic traces are generated may be fixed, additively combining seismic traces effectively reduces the number of 3D images which can be generated, thereby reducing the 4D calendar resolution. Alternatively, the frequency with which seismic traces are generated may be increased. However, generating additional seismic traces may increase equipment costs and data processing costs. Often, such implementations are unfeasible. Accordingly, the present disclosure relates generally to systems and methods to reduce noise in seismic data using a frequency dependent calendar filter.

### SUMMARY

In accordance with one or more embodiments of the present disclosure, a method for reducing noise in input seismic trace data is disclosed. The method includes obtaining a plurality of input seismic trace data, the plurality of repeated input seismic trace data including a plurality of controlled signals and a plurality of uncontrolled signals, identifying a frequency content of the plurality of uncontrolled signals, and selecting a frequency dependent calendar filter based on the frequency content of the plurality of uncontrolled signals. The method further includes applying the frequency dependent calendar filter to the plurality of input seismic data to generate a plurality of output noise-reduced seismic traces.

In accordance with one or more embodiments of the present disclosure, a system for reducing noise in input seismic trace data is disclosed, the system including a receiver configured to receive seismic data and a seismic computing system communicatively coupled to the receiver. The seismic computing system is configured to obtain a plurality of input seismic trace data, the plurality of input seismic trace data including a plurality of controlled signals and a plurality of uncontrolled signals, and identify a frequency content of the plurality of uncontrolled signals. The system is further configured to select a frequency dependent calendar filter based on the frequency content of the plurality of uncontrolled signals; and apply the frequency dependent calendar filter to the plurality of input seismic data to generate a plurality of output noise-reduced seismic traces.

In accordance with one or more embodiments of the present disclosure, a non-transitory computer-readable medium containing instructions for reducing noise in input seismic trace data is disclosed. The instructions are operable, when executed by a processor, to obtain a plurality of input seismic trace data, the plurality of input seismic trace data including a plurality of controlled signals and a plurality of uncontrolled signals, and to identify a frequency content of the plurality of uncontrolled signals. The instructions are further operable, when executed by a processor, to select a frequency dependent calendar filter based on the frequency content of the plurality of uncontrolled signals; and apply the frequency dependent calendar filter to the plurality of input seismic data to generate a plurality of output noise-reduced seismic traces.

### BRIEF DESCRIPTION OF THE DRAWINGS

For a more complete understanding of the present disclosure and its features and advantages, reference is now made to the following description, taken in conjunction with the accompanying drawings, which may include drawings that are not to scale and wherein like reference numbers indicate like features, in which:

FIG. 1 illustrates an exemplary set of input seismic trace data in accordance with some embodiments of the present disclosure;

FIG. 2 illustrates graphs depicting exemplary frequency content of input seismic trace data and frequency content of uncontrolled sources, in accordance with some embodiments of the present disclosure;

FIG. 3A illustrates an exemplary frequency dependent calendar filter in accordance with some embodiments of the present disclosure;

FIG. 3B illustrates a flow chart of an exemplary method for selecting filter coefficient values in a frequency dependent calendar filter in accordance with some embodiments of the present disclosure;

FIG. 4 illustrates an exemplary application of a frequency dependent calendar filter to input seismic trace data in accordance with some embodiments of the present disclosure;

FIG. 5 depicts exemplary applications of a frequency dependent calendar filter to sequential input seismic trace data in accordance with some embodiments of the present disclosure;

FIG. 6 illustrates a flow chart of an exemplary method for reducing noise in seismic data using a frequency dependent calendar filter in accordance with some embodiments of the present disclosure;

FIG. 7 illustrates a cross-sectional view of a seismic imaging system that may be used to generate seismic signal data, in accordance with some embodiments of the present disclosure; and

FIG. 8 illustrates a schematic of an exemplary system for reducing noise in input seismic trace data, in accordance with some embodiments of the present disclosure.

### DETAILED DESCRIPTION

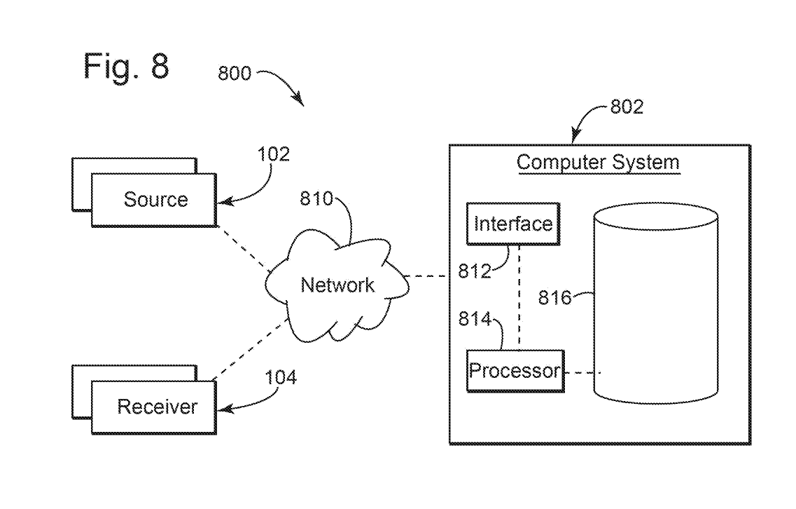

Embodiments of the present disclosure utilize a frequency dependent calendar filter to reduce noise in repeated seismic trace data. Controlled signals and uncontrolled signals are recorded and transmitted to a seismic data tool at intervals. Uncontrolled signals may be analyzed to determine a frequency content of the uncontrolled signals. This analysis of the frequency content of the uncontrolled signals can be performed using seismic trace input data itself and/or by using additional seismic data. Alternatively, the frequency content of the uncontrolled signals can simply be predicted based on a priori knowledge. Frequency content of the uncontrolled signals may be described with references to parameters such as component frequencies (“Fourier modes”) and associated amplitudes. Analysis of the frequency content of uncontrolled signals may be used to select or design a frequency dependent calendar filter for use in reducing noise in seismic traces. In some embodiments, a seismic data tool, such as seismic computing system 802, discussed below in conjunction with FIG. 8, may be used to reduce noise in seismic traces. Receivers may receive and transmit, to the seismic data tool, data corresponding to the amplitude of seismic signals. When taking repeated surveys, adjusting the seismic traces from a survey based on the frequency content of the uncontrolled signals provides a picture of changes in subsurface formations that are relevant to reservoir production.

Noise may be reduced in seismic traces by applying frequency dependent calendar filters to seismic traces at any suitable point during the imaging process. Frequency dependent calendar filters may include coefficients defined in a Frequency-calendar Time space. Seismic traces may be converted to the frequency domain, and adjusted by applying a frequency dependent calendar filter to reduce noise in seismic traces during repeated or continuous monitoring of a survey site.

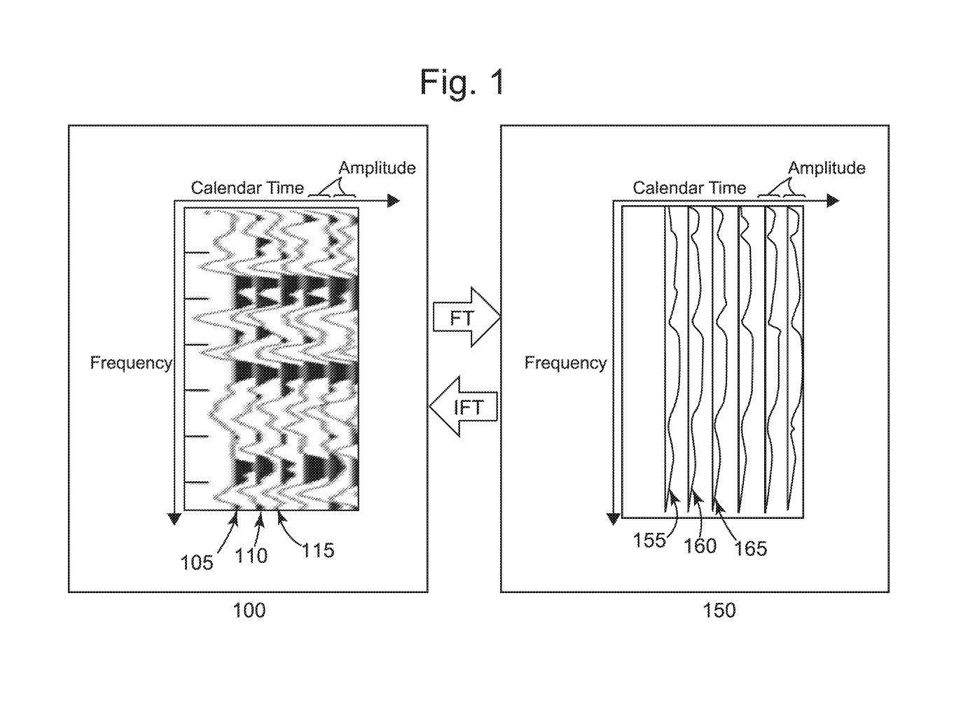

FIG. 1 illustrates an exemplary set of input seismic trace data in accordance with some embodiments of the present disclosure. Graph 100 depicts exemplary input seismic trace data in the time domain, and graph 150 depicts the same exemplary input seismic trace data in the frequency domain. Input seismic trace data may also be referred to as “trace data,” “seismic traces,” or “raw data,” or “repeated seismic experiment records.”

Although the particular manner in which data is displayed does not affect the application of a frequency dependent calendar filter, exemplary graphs 100 and 150 may be used to illustrate the process of converting seismic data between the time and frequency domains. Accordingly, certain features of graphs 100 and 150 will be described herein. The x-axis of both graph 100 and graph 150 depicts both a time when the measurement was received and transmitted to a seismic data tool, and amplitude of that measurement. The time when the measurement was received is represented by the order of seismic traces, such as input seismic trace data 105, 110, and 115. In some embodiments, the time when the measurement was received is expressed in a unitless sequence of measurement order, known as “calendar time.” In other embodiments, the time when the measurement was received is expressed in time units, such as hours, days or weeks (eventually months, years, decades). For each trace, the x-axis also represents the amplitude of input seismic trace data. With respect to graph 100, the y-axis represents the two-way travel time between a source to a sensor, typically reported in milliseconds (ms). On graph 150, the y-axis is in the frequency domain. Values along the y-axis of graph 150 may correspond to different frequency components of input seismic traces.

Graphs 100 and 150 both include input seismic trace data. For example, graph 100 depicts input seismic trace data 105, 110, and 115 in the time domain. In the time domain, each instance of an input seismic trace includes data corresponding to the amplitude of a measured signal over time. For example, input seismic trace data 105 may represent successive instances of measurements recorded and transmitted to a seismic data tool by a particular receiver. In particular, controlled sources may generate controlled signals, which may be received and transmitted to a seismic data tool by receivers. However, while controlled sources are operating, uncontrolled sources may also be emitting uncontrolled signals, which may also be received and transmitted to a seismic data tool by receivers. Accordingly, input seismic trace data 105 may include components of both controlled signals and uncontrolled signals. The shape of input seismic trace data corresponds to the amplitude of the received signals. Specifically, particular contours of the curve may correspond to subsurface geological features.

Typically, frequency dependent calendar filters are applied to input seismic data in the frequency domain, rather than in the time domain. Accordingly, as shown in FIG. 1, input seismic data may be converted from the time domain to the frequency domain using a Fourier transform (“FT”). Alternatively, a Fast Fourier transform (“FFT”), or any other suitable transformation methods may be used. Correspondingly, after frequency dependent calendar filter is applied, input seismic data may be converted back from the frequency domain to the time domain using an inverse Fourier transform (“IFT”). Alternatively, an inverse Fast Fourier transform (“IFFT”), or any other suitable transformation methods may be used.

Graph 150 illustrates exemplary input seismic trace data in the frequency domain. Specifically, Graph 150 depicts exemplary input seismic trace data 155, 160, and 165 in the frequency domain. Input seismic trace data 155, 160, and 165 may correspond to input seismic trace data 105, 110, and 115, respectively. For example, input seismic trace data 105 may be converted from the time domain into the frequency domain using a Fourier transform, resulting in input seismic trace data 155. Input seismic trace data 155, 160 and 165 in the frequency domain may include associated Fourier modes and amplitudes. Specifically, each Fourier mode may correspond to a particular frequency component of an input seismic trace. Further, each Fourier mode may have an associated amplitude corresponding to the magnitude of the frequency content of input seismic trace data at a particular Fourier mode.

Amplitudes and associated Fourier modes may thus depend on the combined frequency content of controlled signals and uncontrolled signals.

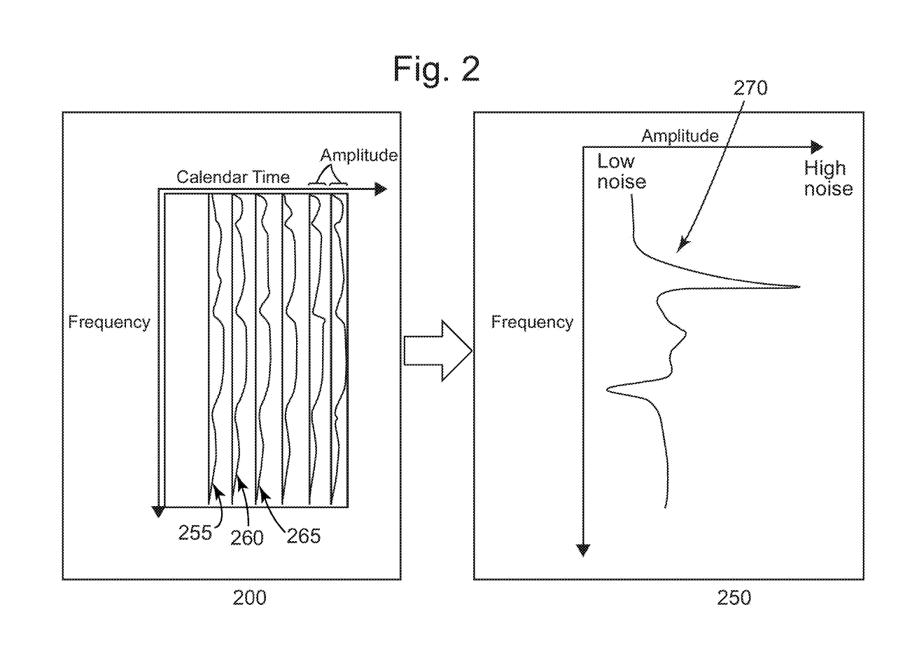

FIG. 2 illustrates graphs depicting exemplary frequency content of input seismic trace data and frequency content of uncontrolled sources, in accordance with some embodiments of the present disclosure. Specifically, graph 200 depicts exemplary input seismic trace data in the frequency domain, and graph 250 depicts uncontrolled seismic signal data 270 derived from the exemplary input seismic data in graph 200. Similar to graph 100, discussed above with respect to FIG. 1, the x-axis of graph 200 represents a time when the measurement was received and transmitted to a seismic data tool and an amplitude of the measurement. Likewise, values along the y-axis of both graph 200 and graph 250 may correspond to different frequency components of input seismic trace data. The x-axis of graph 250 represents an amplitude of uncontrolled seismic signal data. Uncontrolled signal amplitude may be reported in decibels or any other suitable unit.

In some embodiments, to reduce noise in seismic signal data, the frequency content of uncontrolled sources may be identified. Identifying frequency content of uncontrolled signals may include calculating uncontrolled signal amplitudes for various component frequencies of an uncontrolled signal, such as, for example, calculating amplitudes associated with frequencies of Fourier modes of input seismic trace data in the frequency domain. In some embodiments, multiple instances of input seismic trace data, such as exemplary input seismic trace data 255, 260, and 265, may be combined to create a reference seismic trace. For example, input seismic trace data may be averaged to create a reference seismic trace. However, any suitable operation may be used to combine input seismic trace data may be used. For example, a reference seismic trace may be created by using a median, or weighted average of input seismic trace data.

Creation of a reference seismic trace may occur in either the time domain or the frequency domain. Because uncontrolled signals are often uncorrelated while controlled signals are typically well correlated, combining multiple input seismic trace data to create a reference seismic trace may minimize the effects of uncontrolled signals on the reference seismic trace. After creating a reference seismic trace, uncontrolled seismic signal data 270 may be calculated by subtracting the references trace from any suitable instance of input seismic trace data (for example input seismic trace data 205). Again, because uncontrolled signals are often uncorrelated, while controlled signals are typically well correlated, removal of the reference seismic trace from a particular input seismic trace data may identify frequency content of uncontrolled seismic signal data. The amplitudes and frequencies of various Fourier modes of uncontrolled seismic signal data may correspond to the frequency content of uncontrolled sources. For example, in some embodiments, where input seismic trace data is in the frequency domain, the noise at a particular frequency may be estimated according to equation (1):

$${noise}_{f} \approx {t}_{0 , f} - \frac{{\sum }_{i = 0}^{n} {t}_{i , f}}{n} \qquad ( 1 )$$

where:
f is a Fourier mode of the input seismic trace data,
t_{a, f} is the amplitude of input seismic trace data for calendar time offset
a at Fourier mode f, and
n is the total number of calendar time indices with corresponding input seismic trace data.
   Although the example in equations (1) subtracts the reference seismic trace from input seismic trace data at calendar time offset 0, the reference seismic trace may be subtracted from any suitable instance of input seismic trace data. Alternatively, uncontrolled seismic signal data can be estimated using any suitable a priori information about the frequency content of uncontrolled seismic signal data. For example, uncontrolled seismic signal data could be directly measured using a receiver. Alternatively, uncontrolled seismic signal data could be modelled synthetically based on knowledge of typical uncontrolled sources in an exploration area.

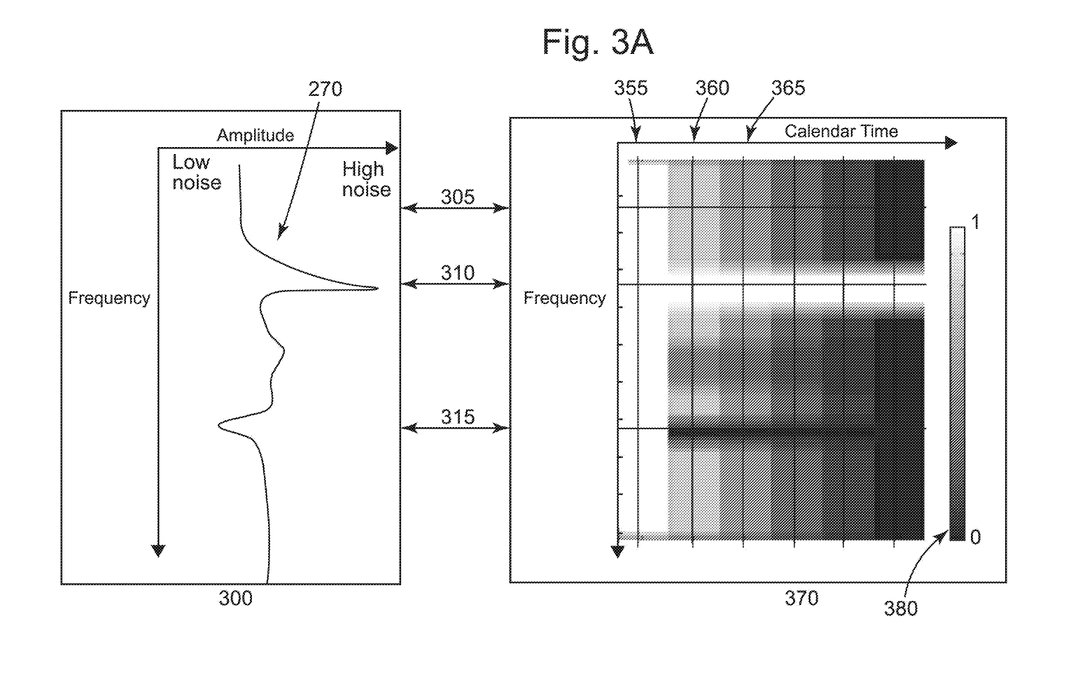

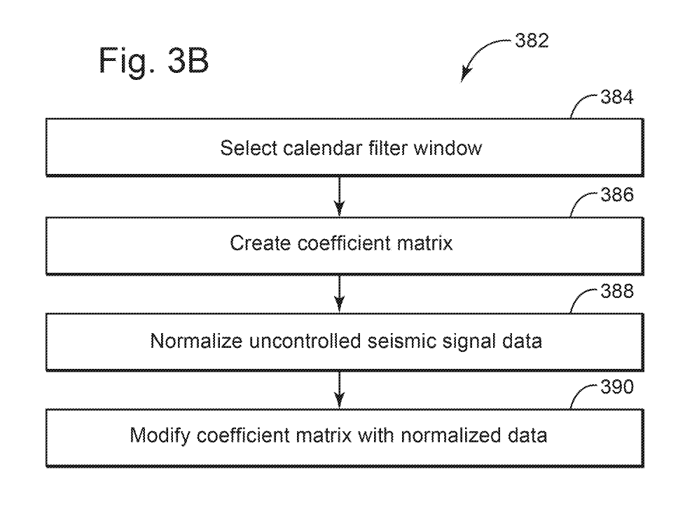

In some embodiments, based on the frequency content of uncontrolled seismic signal data, a frequency dependent calendar filter may be designed or selected. FIG. 3A illustrates an exemplary frequency dependent calendar filter in accordance with some embodiments of the present disclosure. For reference, graph 300 depicts uncontrolled seismic signal data 270, also depicted in FIG. 2, derived from exemplary input seismic data. Similar to graph 200, the x-axis of graph 300 represents an amplitude of uncontrolled seismic signal data. The y-axis of graph 300 represents the Fourier modes of exemplary uncontrolled seismic signal data 270 in the frequency domain.

In some embodiments, frequency dependent calendar filter 370 may include a set of coefficients defined in a frequency-calendar time space, but any suitable numerical space may be used. Specifically, frequency dependent calendar filter 370 may include a set of filter coefficient values for each Fourier mode of uncontrolled seismic signal data or for each Fourier mode of input seismic data in the frequency domain. For example, each calendar time when a seismic signal is received may have one or more associated coefficients. As depicted in FIG. 3A, the values of coefficients in frequency dependent calendar filter 370 are represented graphically, accordingly to legend 380. Legend 380 indicates that the darkest cells represent a coefficient of 0, while the lightest cells represent a coefficient of 1, but any suitable range of coefficients may be used.

FIG. 3B illustrates a flow chart of an exemplary method for selecting filter coefficient values in a frequency dependent calendar filter in accordance with some embodiments of the present disclosure. This sequence is provided as an example, and various embodiments may perform all, some, or none of these steps. The steps of method 382 are performed by a user, various computer programs, models configured to process or analyze seismic data, or any combination thereof. For example, the steps of method 382 may be performed by a seismic data tool, such as seismic computing system 802, discussed below with reference to FIG. 8. The programs and models include instructions stored on a computer readable medium and operable to perform, when executed, one or more of the steps described below. The computer readable media includes any system, apparatus or device configured to store and retrieve programs or instructions such as a hard disk drive, a compact disc, flash memory, or any other suitable device. The programs and models are configured to direct a processor or other suitable unit to retrieve and execute the instructions from the computer readable media. Collectively, the user or computer programs and models used to process and analyze seismic data may be referred to as a “seismic computing system.” Certain embodiments may perform different steps in addition to or in place of the illustrated steps discussed below.

At step 384, a seismic computing system selects a calendar filter window. The maximum offset between the calendar time corresponding to the seismic signal data to be noise reduced and another calendar time with a non-zero coefficient may be referred to as a “window.” A calendar filter window may encompass both leading and trailing input traces. For example, during real time application of a frequency dependent calendar filter, a window may include only trailing traces, because leading traces have not yet been acquired. Alternatively, during post processing of existing data, a window may include any suitable combination of leading or training traces. Selection of a calendar filter window may depend on amplitude of uncontrolled seismic signals, and on desired resolution in 4D seismic images. A wider window will achieve greater noise reduction, at the cost of decreased resolution. Any suitable window may be selected. For example, in a repeated seismic experiment where traces are acquired on a daily basis with typical noise amplitude, a window may be 14 calendar time intervals, including 7 leading and 7 trailing traces. In the example depicted in FIG. 3A, the calendar filter window includes 5 leading traces.

At step 386, the seismic computing system creates an initial coefficient matrix. An initial coefficient matrix may include a coefficient value for each Fourier mode of input seismic signal data and for each calendar time within the calendar filter window. Typically, coefficients in an initial coefficient matrix vary as a function of calendar time offset, but include the same coefficient values for each Fourier mode. For example, the entries at calendar time 0 may be assigned coefficients of 1 for each Fourier mode, while the entries at the edge of the calendar filter window may be assigned a coefficient of 0 for every Fourier mode. The coefficients within the calendar filter window may vary between 1 and 0 according to any suitable function. For example, coefficients may be selected to decrease linearly with increasing calendar time offset. As shown in the exemplary filter in FIG. 3A, as calendar time offset increases, coefficient values decrease linearly. Alternatively, initial coefficients may be selected using any other suitable function (such an exponential, quadratic, logarithmic, or polynomial function), or initial coefficients may be manually assigned.

At step 388, the seismic computing system normalizes uncontrolled seismic signals. Normalized uncontrolled seismic signals may be generated by determining the maximum amplitude of uncontrolled seismic signals, and then dividing the amplitude of uncontrolled seismic signals at each Fourier mode by the maximum amplitude. The amplitude of normalized uncontrolled seismic signals thus ranges between 0 and 1. In the example shown in FIG. 3A, normalized uncontrolled seismic signals amplitude will be 1 at Fourier mode 310, while normalized uncontrolled seismic signals amplitude will have its minimum value at Fourier mode 315.

At step 390, the seismic computing system modifies the initial coefficient matrix using the normalized uncontrolled seismic signals. The coefficients of a frequency dependent calendar filter may be generated by modifying the initial coefficient matrix using the normalized uncontrolled seismic signals. For example, the coefficients for each calendar time offset may be multiplied by the normalized uncontrolled seismic signals. Thus, in some embodiments, the coefficients of a frequency dependent calendar filter for a particular calendar time offset and Fourier mode may be equal to the product of the initial coefficient value assigned to that calendar time offset and the amplitude of normalized uncontrolled seismic signals for that Fourier mode. Accordingly, as depicted in FIG. 3A, for Fourier modes where uncontrolled seismic signal data has a higher amplitude, such as Fourier mode 310, the resulting coefficient values may be higher. Correspondingly, for Fourier modes where uncontrolled seismic signal data has a lower amplitude, such as Fourier mode 315, coefficient values may be lower.

In some embodiments, method 382 may iterate through steps 384-390, or a subset of steps 384-390 multiple times. Various embodiments may perform some, all, or none of the steps described above. For example, certain embodiments may perform certain steps in different orders or in parallel, and certain embodiments may modify one or more steps. Moreover, one or more steps may be repeated. Additionally, while a computing system has been described as performing these steps, any suitable component of systems may perform one or more steps. For example, seismic computing system 802 (shown in FIG. 8) may perform all or some of the steps described above.

Although method 382 describe one example of how to generate coefficients of a frequency dependent calendar filter, any other suitable method may be used. For example, a preexisting frequency dependent calendar filter may be obtained, or, alternatively, each coefficient may be manually selected. In some embodiments, a frequency dependent calendar filter may be designed by iteratively testing and modifying a manually designed frequency dependent calendar filter until a suitable balance between noise reduction and resolution is achieved.

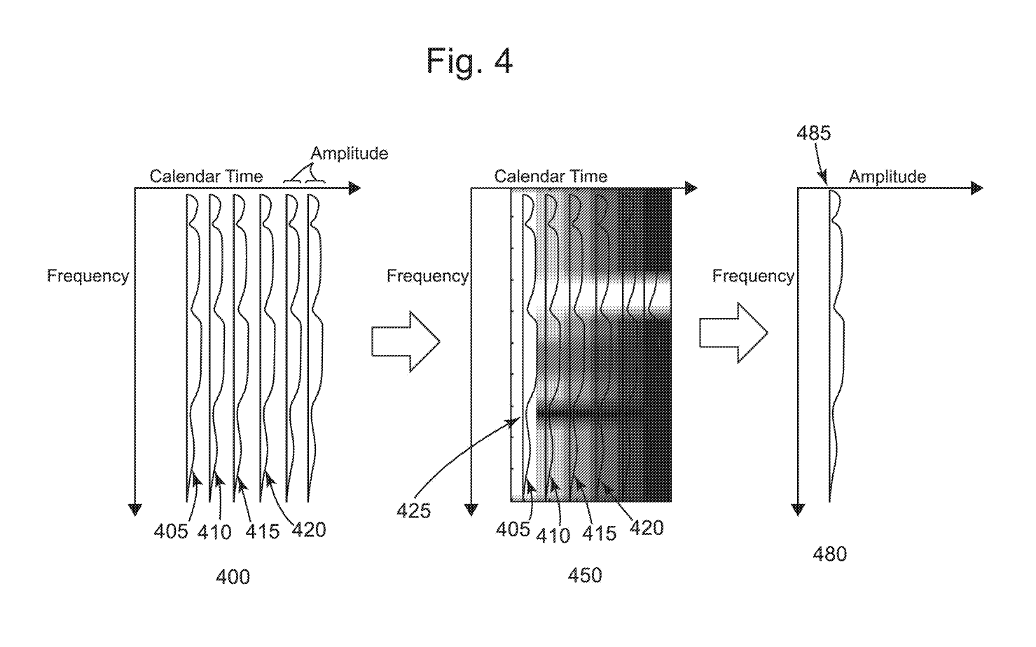

FIG. 4 illustrates an exemplary application of a frequency dependent calendar filter to input seismic trace data in accordance with some embodiments of the present disclosure. Graph 400 depicts exemplary input seismic data in the frequency domain, including input seismic trace data 405, 410 and 415. Graph 480 depicts exemplary noise reduced seismic signal data 485. Similar to graph 100, discussed above with respect to FIG. 1, the x-axis of graphs 400 and 480 represents a time when a measurement was received and transmitted to a seismic data tool. Likewise, values along the y-axis of graphs 400 and 480 may correspond to different frequency components of input seismic trace data. Applying frequency dependent calendar filter 425 to input seismic trace data may be conceptually viewed as overlaying frequency dependent calendar filter 425 on input seismic trace data, as shown in graph 450. For each Fourier mode, the amplitude of input seismic trace data may be multiplied by the corresponding coefficient value in frequency dependent calendar filter 425. The resultant values may be summed and divided by the sum of the corresponding coefficients to calculate the amplitude of noise reduced seismic signal 485, shown in graph 480. This process can be expressed mathematically:

$${NRT}_{f} \approx \frac{{\sum }_{i = 0}^{n} {T}_{i , f} * {C}_{i , f}}{{\sum }_{i = 0}^{n} {C}_{i , f}} \qquad ( 2 )$$

where:
f is a Fourier mode of the input seismic trace data,
NRT_{i,f} is the amplitude of the noise reduced seismic trace at calendar time offset i and Fourier mode f,
T_{i,f} is the amplitude of the input seismic data at calendar time offset i and Fourier mode f,
C_{i,f} is the coefficient of the frequency dependent calendar filter for calendar time offset i and Fourier mode f, and
n is the size of the frequency dependent calendar filter window.

Accordingly, each amplitude associate of a particular Fourier mode of noise reduced seismic signal 485 may be a weight average of the amplitudes of input seismic trace data where the weights are the frequency calendar filter coefficients (425), such as input seismic trace data 405, 410, 415, and 420. Accordingly, 4D seismic analysis may be performed using noise reduced seismic signal 485 rather than input seismic trace 405. An instance of noise reduced seismic signals may be calculated for each instance of input seismic trace data, such as input seismic trace data 405, 410, 415 and 420.

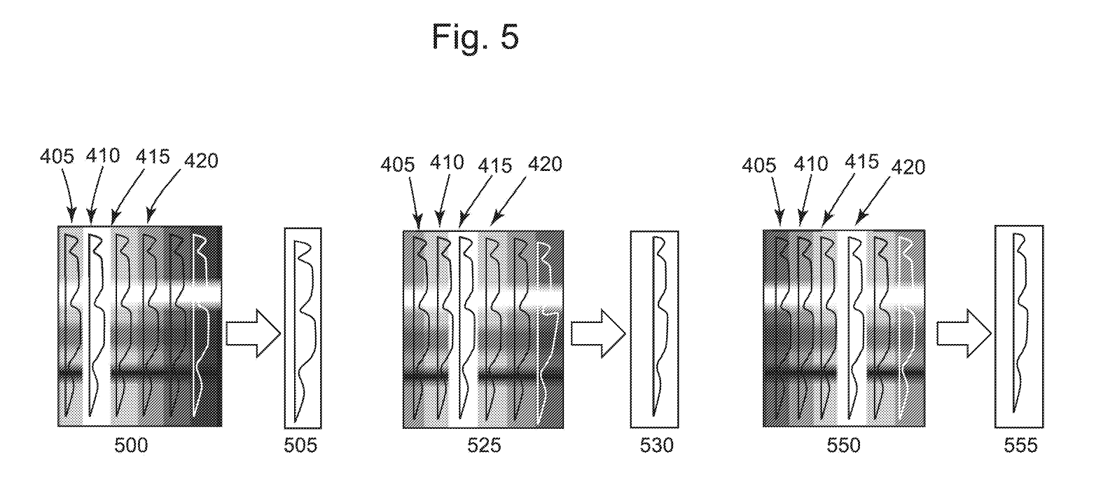

FIG. 5 depicts exemplary applications of a frequency dependent calendar filter to sequential input seismic trace data in accordance with some embodiments of the present disclosure. To calculate noise reduced seismic signals, frequency dependent calendar filter may be applied to different input seismic trace data. As depicted in graphs 500, 525 and 550, frequency dependent calendar filter may be time shifted by a calendar time offset, and a noise reduced seismic signal may be calculated. For example, noise reduced seismic signal 505 may be correspond to input seismic trace data 410, noise reduced seismic signal 530 may be correspond to input seismic trace data 415, and noise reduced seismic signal 555 may be correspond to input seismic trace data 420. Accordingly, 4D seismic analysis may be performed using noise reduced seismic signals 505, 530 and/or 555 rather than input seismic trace 410, 415, and/or 420. 4D seismic analysis may include comparing various instances of noise reduced seismic signals. For example, a 4D seismic image may be generated by aggregating noise reduced seismic traces from various calendar times. Furthermore, 4D seismic analysis identifying a change in a geophysical property of a subsurface formation with the 4D seismic image. For example, noise reduced seismic signals may be compared to determine whether a subsurface geologic feature has changed across calendar times based on an anthropogenic event. 4D seismic analysis may be performed in either the time domain or in the frequency domain.

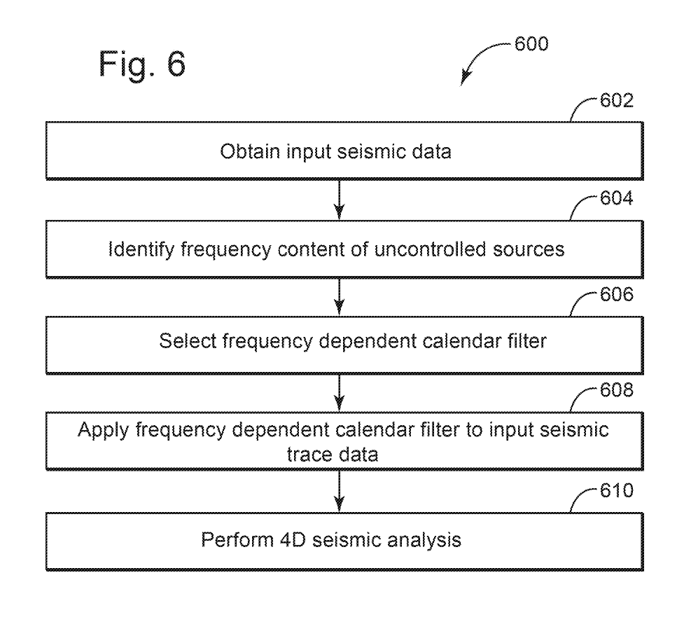

FIG. 6 illustrates a flow chart of an exemplary method for reducing noise in seismic data using a frequency dependent calendar filter in accordance with some embodiments of the present disclosure. This sequence is provided as an example, and various embodiments may perform all, some, or none of these steps. The steps of method 600 are performed by a user, various computer programs, models configured to process or analyze seismic data, or any combination thereof. For example, the steps of method 600 may be performed by a seismic data tool, such as seismic computing system 802, discussed below with reference to FIG. 8. The programs and models include instructions stored on a computer readable medium and operable to perform, when executed, one or more of the steps described below. The computer readable media includes any system, apparatus or device configured to store and retrieve programs or instructions such as a hard disk drive, a compact disc, flash memory, or any other suitable device. The programs and models are configured to direct a processor or other suitable unit to retrieve and execute the instructions from the computer readable media. Collectively, the user or computer programs and models used to process and analyze seismic data may be referred to as a “seismic computing system.” For illustrative purposes, method 600 is described with respect to input seismic trace data 105, 110, and 115 of FIG. 1; however, method 600 may be used to perform noise reduction using frequency dependent calendar filters using any suitable seismic data set. Furthermore, certain embodiments may perform different steps in addition to or in place of the illustrated steps discussed below. This sequence may also be repeated any suitable number of times to reduce noise in input seismic trace data associated with different surveys performed at different time periods.

At step 602, the seismic computing system obtains or receives input seismic trace data. Input seismic trace data may include controlled signals and uncontrolled signals. Controlled signals may be generated by controlled sources, while uncontrolled signals may be generated by uncontrolled sources. Input seismic trace data may be received and transmitted to the computing system by receivers. In some embodiments, signals may be received and transmitted to the computing system periodically. For example, signals may be received and transmitted to the computing system each day, week, month, year, or any suitable amount of time apart.

At step 604, the seismic computing system may identify frequency content of uncontrolled signals. Identification of the frequency content of uncontrolled signals may include averaging input seismic trace data to create a reference trace. Identification of the frequency content of uncontrolled signals may further include creating uncontrolled seismic signal data by differencing the input seismic trace data and the reference trace. Differencing may include subtraction, or any other suitable comparison. Alternatively, uncontrolled seismic signal data can be estimated using any suitable a priori information about the frequency content of uncontrolled seismic signal data. For example, uncontrolled seismic signal data could be directly measured using a receiver. Alternatively, uncontrolled seismic signal data could be modelled synthetically based on knowledge of typical uncontrolled sources in an exploration area.

At step 606, the seismic computing system may select a frequency dependent calendar filter. Selection of a frequency dependent calendar filter, such as frequency dependent calendar filter 370, shown in FIG. 3A, may be based on the frequency content of uncontrolled signals. Selecting frequency dependent calendar filter may include selecting a set of filter coefficient values for each Fourier mode of uncontrolled seismic signal data or for each Fourier mode of input seismic data in the frequency domain. Frequency dependent calendar filters may be designed or selected to minimize the contribution of uncontrolled signals to seismic data relative to the contribution of controlled signals.

At step 608, the seismic computing system may apply a frequency dependent calendar filter to the input seismic trace data. For example, frequency dependent calendar filter from step 606 may be applied to input seismic trace data in the frequency domain. Applying frequency dependent calendar filter may include adjusting the amplitude of various input seismic trace data according to the filter coefficient values of the frequency dependent calendar filter, and summing the results to create noise reduced seismic signal data.

At step 610, the seismic computing system may perform 4D seismic processing. 4D seismic analysis may include comparing various instances of noise reduced seismic signals. For example, a 4D seismic image may be generated by aggregating noise reduced seismic traces from various calendar times. Furthermore, 4D seismic analysis identifying a change in a geophysical property of a subsurface formation with the 4D seismic image. For example, noise reduced seismic signals may be compared to determine whether a subsurface geologic feature has changed across calendar times based on an anthropogenic event.

In some embodiments, method 600 may iterate through steps 602-610, or a subset of steps 602-610 multiple times. Receivers may therefore be periodically or continuously receiving and transmitting signals to the computing system. Processing seismic data in this manner may reduce noise attributable to uncontrolled signals during repeated or continuous acquisition cycles so that 4D images reflect the state of the subsurface geology, which may improve the effectiveness and efficiency of reservoir production operations and reduce costs.

Various embodiments may perform some, all, or none of the steps described above. For example, certain embodiments may perform certain steps in different orders or in parallel, and certain embodiments may modify one or more steps. For example, multiple sets of uncontrolled signals may be processed in parallel. Moreover, one or more steps may be repeated. Additionally, while a computing system has been described as performing these steps, any suitable component of systems may perform one or more steps. For example, seismic computing system 802 (shown in FIG. 8) may perform all or some of the steps described above.

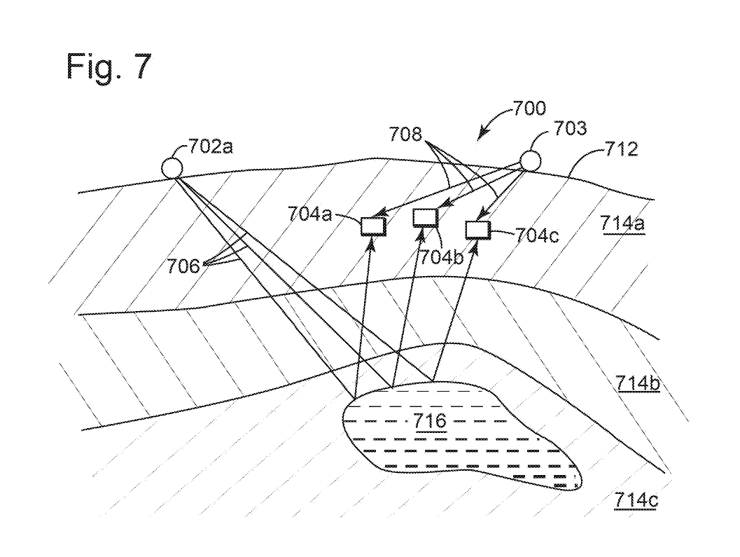

FIG. 7 illustrates a cross-sectional view of a seismic imaging system 700 that may be used to generate seismic signal data, in accordance with some embodiments of the present disclosure. In the illustrated embodiment, system 700 includes controlled source 702 and receivers 704. Receivers 704 may recorded and transmitted seismic signals generated by controlled sources 702 and uncontrolled sources 703 to a seismic data tool. System 700 is located in an area that includes surface 712, layers 714, and reservoir 716. Although FIG. 7 depicts a land implementation of system 700, embodiments of the present disclosure may also be used in marine, transition zones, or in any other environment where seismic imaging is performed.

System 700 may reduce noise in input seismic trace data by applying a frequency dependent calendar filter. System 700 may be any collection of systems, devices, or components configured to detect, record, and/or process seismic data. System 700 may include one or more controlled sources 702 and one or more receivers 704. Seismic waves (such as, for example, acoustic wave trains) propagate out from one or more controlled sources 702 and may be partially reflected, refracted, diffracted, or otherwise affected by one or more subsurface structures such as rock layers beneath the earth's surface. These waves are ultimately received and transmitted to a seismic data tool by one or more receivers 704 and processed to generate images of the subsurface. Each instance of a receiving and transmitting signals by receiver 704 may be called a seismic trace, or input seismic trace data. As explained above, input seismic trace data recorded as different times may be used to generates 3D images. Further, 3D images taken at different times can be compared to generate 4D images that show changes in subsurface formations over time. Reducing noise in input seismic trace data based on the frequency content of uncontrolled seismic data provides improved 4D imaging that emphasizes the 4D signal and provides a clearer picture of subsurface changes that are relevant to reservoir production.

Controlled sources 702 may be any devices that generate controlled seismic waves that are used to generate images of geological structures. Controlled source 702, which can be impulsive or vibratory, generates controlled signals 106. In particular embodiments, controlled source 702 can be a seismic vibrator, vibroseis, dynamite, air gun, thumper truck, piezoelectric-source, or any other suitable seismic energy source. Source 702 may utilize electric motors, counter-rotating weights, hydraulics, or any other suitable structure configured to generate seismic energy. System 700 can have any suitable number, type, configuration, or arrangement of controlled sources 702. For example, system 700 can include multiple controlled sources 702 that operate in conjunction with one another. In such embodiments, controlled sources 702 can be operated by a central controller that coordinates the operation of multiple controlled sources 702. As another example, controlled sources 702 may be located on surface 712, above surface 712, or below surface 712. Furthermore, in some embodiments, a positioning system may be utilized to locate, synchronize, or time-correlate sources 702. For example, some embodiments utilize a Global Navigation Satellite System (GNSS) such as, for example, the Global Positioning System (GPS), Galileo, the BeiDou Satellite Navigation System (BDS), GLONASS, or any suitable GNSS system. Additional structures, configurations, and functionality of controlled sources 702 are described below with respect to FIG. 8.

Uncontrolled source 703 may be any object, location, or event that emits incidental seismic waves that are not deliberately triggered by system 700. For example, uncontrolled sources 703 can be natural phenomena such as rain, waves, earthquakes, volcanic eruptions, or any other natural event that generates seismic waves. Uncontrolled sources 703 can also be anthropogenic objects or events such as, for example, cars, boats, drilling or pumping-related activity or machinery, or any human-related events. Uncontrolled sources 703 may be transitory or permanent and may be stationary or mobile. Uncontrolled signals 708 may be generated from any number or type of uncontrolled source 703, and uncontrolled sources 703 may have any location relative to receivers 704 that allows their emissions to be recorded.

Receivers 704 may be any devices that are operable to receive and transmit seismic waves. Receivers 704 convert seismic energy into signals, which may have any suitable format. For example, receivers 704 can detect seismic waves as analog signals or digital signals. As a particular example, certain embodiments of receiver 704 convert seismic energy to electrical energy, allowing seismic waves to be detected as electrical signals such as, for example, voltage signals, current signals, or any suitable type of electric signal. Other embodiments of receiver 704 detect seismic energy as an optical signal or any suitable type of signal that corresponds to the received seismic energy. The resulting signals are transmitted to and recorded by recording units that may be local or remote to receivers 704. The resulting recordings may be called input seismic trace data. Input seismic trace data may then be communicated to seismic computing system 802 for processing, as described further below with respect to FIG. 8.

System 700 may utilize any suitable number, type, arrangement, and configuration of receivers 704. For example, system 700 may include dozens, hundreds, thousands, or any suitable number of receivers 704. As another example, receivers 704 may have any suitable arrangement, such as linear, grid, array, or any other suitable arrangements, and spacing between receivers 704 may be uniform or non-uniform. Furthermore, receivers 704 may be located at any suitable position. For example, receivers 704 may be located on surface 712, above surface 712, or below surface 712. Furthermore, in off-shore embodiments, receivers 704 may also be located at any suitable depth within the water.

Receivers 704 may detect seismic waves during periods when controlled sources 702 are generating controlled signals 706. Such periods may be referred to as periods of active acquisition. During periods of active acquisition, receivers 704 may detect both controlled and uncontrolled signals. Such recordings may span days, months, or years. Such detections may be continuous or periodic during this span of time. In some embodiments, signals detected by the same receivers 704 at different times may be used to calculate 4D images that depict apparent changes in the survey area over time. Furthermore, seismic waves detected by receivers 704 may be communicated to seismic computing system 802 for processing, as described further below with respect to FIG. 8.

Controlled signals 706 represent portions of seismic waves generated by controlled source 702 that arrive at receivers 704. Controlled signals 706 may be body waves or surface waves, and controlled signals 706 can reach receivers 704 after travelling various paths. For example, these waves can pass straight to receivers 704, or they can reflect, refract, diffract, or otherwise interact with various subsurface structures. However, for purposes of simplified illustration, only three particular paths are shown.

Uncontrolled signals 708 represent portions of seismic waves generated by uncontrolled source 703 that arrive at receivers 704. For example, these waves can pass straight to receivers 704, or they can reflect, refract, diffract, or otherwise interact with various subsurface structures. Again, however, for purposes of simplified illustration, only three particular paths are shown.

Various embodiments may use any suitable techniques for processing seismic data. For example, in some embodiments, after controlled signals 706 are recorded by receivers 704, the data is collected and organized based on offset distances, such as the distance between a particular controlled source 702 and a particular receiver 704 or the amount of time it takes for signals 706 to reach receivers 704. The amount of time a signal takes to reach a receiver 704 may be referred to as the “travel time.” Data collected during a survey by a particular receiver 704 may be referred to as a “trace” or “input seismic trace data,” and multiple traces may be gathered, processed, and utilized to generate a model of the subsurface structure. A “gather” refers to any set of seismic data grouped according to a common feature. For example, a series of traces reflected from the same common subsurface point may be referred to as a common midpoint gather (CMP). Other examples of gathers include common conversion point (CCP) gather, a common shot gather (one source 702 or shot received by multiple receivers 704), common receiver gather (multiple sources 702 received by one receiver 704) (CRG), or any other suitable type of gather based on the implementation or goals of the processing. The traces from a gather may be summed (or “stacked”), which may improve the signal-to-noise ratio (SNR) over a “single-fold” stack because summing tends to cancel out incoherent noise. A “fold” indicates the number of traces in a gather. Additional processing techniques may also be applied to the seismic traces to further improve the resulting images. As explained above, noise can be reduced from the seismic traces at any suitable point during the imaging process. For example, de-noising can be performed on pre-stack or post-stack data.

Surveys can be conducted in any suitable area, including on-shore locations, offshore locations, transition zones, or any other suitable area. Such areas may or may not be utilized for production during the survey period. For example, the survey area may include a reservoir 716 that is being actively developed, and surveys may be conducted continuously or periodically during the period of production. De-noising seismic trace data in such embodiments provides more accurate information about changes in and around reservoir 716 that are relevant to production. Such information may improve production efficiency, reduce costs, and provide other benefits related to reservoir production.

Surface 712 represents the surface of the earth. Surface 712 may be an air-earth boundary or a water-earth boundary depending on the location of the survey. Layers 714a-c (collectively “Layers 714”) represent geological layers. A survey area may have any number, composition, and/or arrangement of layers 714. Body waves may be refracted, reflected, or otherwise affected when traveling through layers 714, particularly at the interfaces between different layers 714. Surface waves may also be attenuated, dispersed, or otherwise affected by geological structures during propagation. Layers 714 may have various densities, thicknesses, or other characteristics that may affect seismic wave propagation.

Reservoir 716 may be any geological formation targeted for production. For example, reservoir 716 may contain oil, gas, or any other targeted material. In embodiments involving actively producing reservoirs 716, reservoir production may cause changes to reservoir 716 (such as, for example, fluid displacement) or the surrounding layers 714 that may affect the optimal exploration or production strategy. Reducing noise in measured signals as described herein may reduce costs, improve production, and improve safety by providing more accurate depictions of the changes in the survey area over time.

FIG. 8 illustrates a schematic of an exemplary system for reducing noise in input seismic trace data, in accordance with some embodiments of the present disclosure. System 800 includes sources 702, receivers 704, and seismic computing system 802, which are communicatively coupled via network 810.

Seismic computing system 802 can reduce noise in input seismic trace data generated by a wide variety of controlled sources 702. For example, seismic computing system 802 can operate in conjunction with controlled sources 702 having any structure, configuration, or function described above with respect to FIG. 7. In particular embodiments, sources 702 are impulsive (such as, for example, explosives or air guns) or vibratory. Impulsive sources may generate a short, high-amplitude seismic signal while vibratory sources may generate lower-amplitude signals over a longer period of time. Vibratory sources may be instructed, by means of a pilot signal, to generate a target seismic signal with energy at one or more desired frequencies, and these frequencies may vary over time. However, the seismic wave actually generated by vibratory source may differ from the target seismic signal.

Noise reduction on input seismic trace data can also be performed in embodiments using controlled sources 702 that radiate one or more frequencies of seismic energy during predetermined time intervals. For example, some embodiments may use controlled sources 702 that generate monofrequency emissions such as, for example, certain SEISMOVIE sources. As another example, some embodiments may use controlled sources 702 that radiate varying frequencies. In such embodiments, controlled source 702 may impart energy at a starting frequency and the frequency may change over a defined interval of time at a particular rate until a stopping frequency is reached. The impartation of a range of frequencies may be referred to as a sweep, frequency sweep, or seismic sweep. The difference between the starting and stopping frequencies of the sweep may be referred to as the range of the sweep and the interval of time to sweep through the frequencies may be referred to as the sweep time. A sweep may be a downsweep, in which the stopping frequency is lower than the starting frequency. By contrast, in an upsweep the stopping frequency is higher than the starting frequency. Furthermore, a sweep may be linear such that the frequency changes linearly over the sweep time at a rate dictated by the starting and stopping frequencies and the sweep time. By contrast, in a nonlinear sweep, the frequency may vary nonlinearly between the starting and stopping frequencies over the sweep time. For example, a nonlinear sweep may include a quadratic sweep, a logarithmic sweep, or any other suitable sweep configuration. In some embodiments, a sweep may be continuous such that controlled source 702 generates substantially all the frequencies between the starting and stopping frequency. In other embodiments, the frequency is gradually increased during the sweep. The gradual increase may be substantially continuous or may use various sized steps to sweep from the starting frequency to the stopping frequency. In some embodiments, a sweep may be discontinuous so that controlled source 702 does not generate particular frequencies between the starting and stopping frequency and receivers 704 do not receive or report data at those particular frequencies.

As explained above, reducing noise in seismic traces is not limited to particular types of receivers 704. For example, in some embodiments, receivers 704 include geophones, hydrophones, accelerometers, fiber optic sensors (such as, for example, a distributed acoustic sensor (DAS)), streamers, or any suitable device. Such devices may be configured to detect and record energy waves propagating through the subsurface geology with any suitable, direction, frequency, phase, or amplitude. For example, in some embodiments, receivers 704 are vertical, horizontal, or multicomponent sensors. As particular examples, receivers 704 may comprise three component (3C) geophones, 3C accelerometers, or 3C Digital Sensor Units (DSUs). In certain marine embodiments, receivers 704 are situated on or below the ocean floor or other underwater surface.

Seismic computing system 802 may include any suitable devices operable to process seismic data recorded by receivers 704. Seismic computing system 802 may be a single device or multiple devices. For example, seismic computing system 802 may be one or more mainframe servers, desktop computers, laptops, cloud computing systems, or any suitable devices. Seismic computing system 802 receives data recorded by receivers 704 and processes the data to select a frequency dependent calendar filter that may be applied to input seismic trace data. Seismic computing system 802 may be operable to perform the methods of custom frequency dependent calendar filters described above with respect to FIG. 7. Seismic computing system 802 may also be operable to coordinate or otherwise control or manage controlled sources 702. Seismic computing system 802 may be communicatively coupled to receivers 704 via network 810 during the recording process, or it may receive the recorded data after the collection is complete. In the illustrated embodiment, computer system 800 includes network interface 812, processor 814, and memory 816.

Network interface 812 represents any suitable device operable to receive information from network 810, transmit information through network 810, perform suitable processing of information, communicate with other devices, or any combination thereof. Network interface 812 may be any port or connection, real or virtual, including any suitable hardware and/or software (including protocol conversion and data processing capabilities) to communicate through a LAN, WAN, or other communication system that allows seismic computing system 802 to exchange information with network 810, other software seismic computing systems 802, controlled sources 702, receivers 704, and/or other components of system 800. Seismic computing system 802 may have any suitable number, type, and/or configuration of network interface 812.

Processor 814 communicatively couples to network interface 812 and memory 816 and controls the operation and administration of seismic computing system 802 by processing information received from network interface 812 and memory 816. Processor 814 includes any hardware and/or software that operates to control and process information. In some embodiments, processor 814 may be a programmable logic device, a microcontroller, a microprocessor, any suitable processing device, or any suitable combination of the preceding. Seismic computing system 802 may have any suitable number, type, and/or configuration of processor 814. Processor 814 may execute one or more sets of instructions to implement custom frequency dependent calendar filters, including the steps described above with respect to FIG. 7. Processor 814 may also execute any other suitable programs to facilitate noise reduction of seismic data such as, for example, user interface software to present one or more GUIs to a user.

Memory 816 may store, either permanently or temporarily, data, operational software, or other information for processor 814, other components of seismic computing system 802, or other components of system 800. Memory 816 includes any one or a combination of volatile or nonvolatile local or remote devices suitable for storing information. For example, memory 816 may include random access memory (RAM), read only memory (ROM), flash memory, magnetic storage devices, optical storage devices, network storage devices, cloud storage devices, solid state devices, external storage devices, or any other suitable information storage device or a combination of these devices. Memory 816 may store information in one or more databases, file systems, tree structures, any other suitable storage system, or any combination thereof. Furthermore, different types of information stored in memory 816 may use any of these storage systems. Moreover, any information stored in memory may be encrypted or unencrypted, compressed or uncompressed, and static or editable. Seismic computing system 802 may have any suitable number, type, and/or configuration of memory 816. Memory 816 may include any suitable information for use in the operation of seismic computing system 802. For example, memory 816 may store computer-executable instructions operable to perform the steps discussed above with respect to FIGS. 1-7 when executed by processor 814. Memory 816 may also store any seismic data or related data such as, for example, input seismic data, reconstructed signals, velocities, amplitudes, signal variations, frequency dependent calendar filters, or any other suitable information.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, “A and B” means “A and B, jointly or severally,” unless expressly indicated otherwise or indicated otherwise by context.

Particular embodiments may be implemented as hardware, software, or a combination of hardware and software. As an example and not by way of limitation, one or more computer systems may execute particular logic or software to perform one or more steps of one or more processes described or illustrated herein. Software implementing particular embodiments may be written in any suitable programming language (which may be procedural or object oriented) or combination of programming languages, where appropriate. In various embodiments, software may be stored in computer-readable storage media. Any suitable type of computer system (such as a single- or multiple-processor computer system) or systems may execute software implementing particular embodiments, where appropriate. A general-purpose computer system may execute software implementing particular embodiments, where appropriate. In certain embodiments, portions of logic may be transmitted and or received by a component during the implementation of one or more functions.

Herein, reference to a computer-readable storage medium encompasses one or more non-transitory, tangible, computer-readable storage medium possessing structures. As an example and not by way of limitation, a computer-readable storage medium may include a semiconductor-based or other integrated circuit (IC) (such as, for example, an FPGA or an application-specific IC (ASIC)), a hard disk, an HDD, a hybrid hard drive (HHD), an optical disc, an optical disc drive (ODD), a magneto-optical disc, a magneto-medium, a solid-state drive (SSD), a RAM-drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of interface 812, one or more portions of processor 814, one or more portions of memory 816, or a combination of these, where appropriate. In particular embodiments, a computer-readable storage medium implements RAM or ROM. In particular embodiments, a computer-readable storage medium implements volatile or persistent memory.

This disclosure encompasses all changes, substitutions, variations, alterations, and modifications to the example embodiments herein that a person having ordinary skill in the art would comprehend. For example, while the embodiments of FIGS. 7 and 8 illustrate particular configurations of controlled sources and receivers, any suitable number, type, and configuration may be used. As another example, any suitable method of calculating reconstructed signals may be used in certain embodiments. As yet another example, while this disclosure describes certain data processing operations that may be performed using the components of system 800, any suitable data processing operations may be performed where appropriate. Furthermore, certain embodiments may alternate between or combine one or more data processing operations described herein.

Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method for reducing noise in input seismic trace data, comprising:
obtaining a plurality of input seismic trace data, the plurality of input seismic trace data including a plurality of controlled signals and a plurality of uncontrolled signals;
identifying a frequency content of the plurality of uncontrolled signals;
selecting a frequency dependent calendar filter based on the frequency content of the plurality of uncontrolled signals; and
applying the frequency dependent calendar filter to the plurality of input seismic data to generate a plurality of output noise-reduced seismic traces.

2. The method of claim 1, wherein the frequency dependent calendar filter comprises a plurality of filter coefficients for each Fourier mode of the plurality of input seismic trace data, the plurality of filter coefficients each associated with a calendar time and including an amplitude adjustment scalar.

3. The method of claim 1, wherein identifying a frequency content of the plurality of uncontrolled signals further comprises:
averaging the plurality of input seismic trace data into a reference seismic trace;
creating a residual seismic trace by subtracting the reference seismic trace from one of the plurality of input seismic traces; and
analyzing the frequency content of the residual seismic traces.

4. The method of claim 1, further comprising:
generating a 4D seismic image based on the plurality of output noise-reduced seismic traces; and
identifying a change in a geophysical property of a subsurface formation with the 4D seismic image.

5. The method of claim 4, further comprising identifying a change in a geophysical property of a subsurface formation with the 4D seismic image.

6. The method of claim 5, wherein change in a geophysical property of a subsurface formation is caused by an anthropogenic source.

7. The method of claim 1, wherein the plurality of input seismic trace data are obtained periodically.

8. A system for reducing noise in input seismic trace data, the system comprising:
a receiver configured to receive seismic data; and
a seismic computing system communicatively coupled to the receiver, the seismic computing system configured to:
obtain a plurality of input seismic trace data, the plurality of input seismic trace data including a plurality of controlled signals and a plurality of uncontrolled signals;
identify a frequency content of the plurality of uncontrolled signals;
select a frequency dependent calendar filter based on the frequency content of the plurality of uncontrolled signals; and
apply the frequency dependent calendar filter to the plurality of input seismic data to generate a plurality of output noise-reduced seismic traces.

9. The system of claim 8, wherein the frequency dependent calendar filter comprises a plurality of filter coefficient values for each Fourier mode of the plurality of input seismic trace data, the plurality of filter coefficients each associated with a calendar time and including an amplitude adjustment scalar.

10. The system of claim 8, wherein identifying a frequency content of the plurality of uncontrolled signals further comprises:
averaging the plurality of input seismic trace data into a reference seismic trace;
creating a residual seismic trace by subtracting the reference seismic trace from one of the plurality of input seismic traces; and
analyzing the frequency content of the residual seismic trace.

11. The system of claim 8, wherein the seismic computing system is further configured to:
generate a 4D seismic image based on the plurality of output noise-reduced seismic traces; and
identify a change in a geophysical property of a subsurface formation with the 4D seismic image.

12. The system of claim 11, wherein the seismic computing system is further configured to identify a change in a geophysical property of a subsurface formation with the 4D seismic image.

13. The system of claim 12, wherein change in a geophysical property of a subsurface formation is caused by an anthropogenic source.

14. The system of claim 8, wherein the plurality of input seismic trace data are obtained periodically.

15. A non-transitory computer-readable medium containing instructions for reducing noise in input seismic trace data, the instructions being operable, when executed by a processor, to:
obtain a plurality of input seismic trace data, the plurality of input seismic trace data including a plurality of controlled signals and a plurality of uncontrolled signals;
identify a frequency content of the plurality of uncontrolled signals;
select a frequency dependent calendar filter based on the frequency content of the plurality of uncontrolled signals; and
apply the frequency dependent calendar filter to the plurality of input seismic data to generate a plurality of output noise-reduced seismic traces.

16. The non-transitory computer-readable medium of claim 15, wherein the frequency dependent calendar filter comprises a plurality of filter coefficient values for each Fourier mode of the plurality of input seismic trace data, the plurality of filter coefficients each associated with a calendar time and including an amplitude adjustment scalar.

17. The non-transitory computer-readable medium of claim 15, wherein identifying a frequency content of the plurality of uncontrolled signals further comprises:
averaging the plurality of input seismic trace data into a reference seismic trace;
creating a residual seismic trace by subtracting the reference seismic trace from one of the plurality of input seismic traces; and
analyzing the frequency content of the residual seismic trace.

18. The non-transitory computer-readable medium of claim 15, the instructions being further operable, when executed by a processor, to:
generate a 4D seismic image based on the plurality of output noise-reduced seismic traces; and
identify a change in a geophysical property of a subsurface formation with the 4D seismic image.

19. The non-transitory computer-readable medium of claim 15, the instructions being further operable identify a change in a geophysical property of a subsurface formation with the 4D seismic image caused by an anthropogenic source.

20. The non-transitory computer-readable medium of claim 15, wherein the plurality of input seismic trace data are obtained periodically.
